(19) United States
(12) Patent Application Publication
(10) Pub. No.: US 2003/0033228 A1
(43) Pub. Date: Feb. 13, 2003

(54) Countermeasures for irregularities in financial transactions

(76) Inventors: Rowan Bosworth-Davies, London (GB); Robert David Norfolk, Worcester (GB); Paul Burd, Tyler's Green (GB)

Correspondence Address: UNISYS Corporation, Unisys Way, MS/E8-114, Blue Bell, PA, 19424-0001, US

(21) Appl. No.: 09/998,360

(22) Filed: Nov. 29, 2001

(30) Foreign Application Priority Data
Nov. 30, 2000 (GB) 0029229.2

(51) Int. Cl. G06F 17/60

(52) U.S. Cl. 705/35

(57) ABSTRACT

A system and method for identifying financial transactions with the potential for financial irregularity (e.g. money laundering) comprises processing (20) financial transactions connected with a client, account and financial application, subjecting the client/account and transaction information to a set of rules (22) to produce numerical outcomes (116, 124, 132) indicative of the potential for money laundering being present. A user of the system is able to vary the weightings associated with each rule according to their importance to the particular circumstances of the institution in question.

### FIELD OF THE INVENTION

This invention relates to countermeasures against irregularities in financial transactions. More particularly, the invention relates to money laundering countermeasures. Still more particularly, the invention relates to systems and methods for enabling financial institutions to meet standards compliance on money laundering countermeasures.

### BACKGROUND OF THE INVENTION

Money laundering is the process of providing a false provenance for money so as to conceal its true origin. It is of benefit to criminals seeking to introduce the proceeds of crime into the legitimate financial world.

The opportunities for devising money laundering techniques have expanded with the increasing flexibility of electronic finds transfer systems. As the volume of financial transactions and the speed of processing them have increased, particularly with the advent of e-commerce, the responsibility on financial institutions in playing their part in detecting and reporting money laundering activity has become more burdensome.

Essentially, the process of detecting a financial transaction that is the subject of an attempt at money laundering is a subjective one. Two people tasked with assessing the same transaction on the basis of client, account and transaction data may well come to different conclusions as to whether it is suspicious or not. Such an assessment assumes the transaction is being dealt with as an individual matter without any constraint of time. The volume of traffic through financial transactions does not allow purely human consideration of each and every transaction. One way to address this is to sample only a fraction of the transactions and to assess them. Of course, this does not provide a comprehensive picture of all the transactions passing through a financial institution. It also relies on chance. While this may lead to a train of enquiry concerning a particular client or account, it is not a comprehensive analysis.

Because money laundering is such a major problem, allowing criminals to enjoy the benefits of their crimes, national governments are looking to financial institutions to provide assistance in the fight against the problem. Financial institutions, such as banks, must set up systems to detect money laundering to be in compliance with, for example, European and/or US money laundering legislation. Other countries have their own compliance criteria. While it might be possible for a financial institution to do business in states in which it complies with the local anti-money laundering requirements, this is not actually a practicable solution. A significant proportion of the world's trade is conducted in US dollars. The anti-money laundering legislation in the United States is particularly burdensome on financial institutions. If money transferred into the United States turns out to be criminal in origin, the US authorities have the power to pursue the financial institution that conducted the transaction through the US courts. As all Dollar transactions have to be subjected to US clearing, there is an automatic US jurisdiction for all dollar-based transactions.

The Organisation for Economic Co-operation and Development (OECD) has established its own Financial Action Task Force on Money Laundering (FATF) which produced ‘The Forty Recommendations’ for best practice compliance with its anti-money laundering objectives. To date twenty-nine states, the European Union and the Gulf Co-operation Counsel are signatories to The Forty Recommendations. Part of these makes uniform the code of practice which the financial institutions have to meet in order to exhibit best practice in money laundering countermeasures. However, there is still the problem of compliance itself even with the beneficial degree of uniformity imposed by The Forty Recommendations.

Recommendation 15 of The Forty Recommendations states that a financial institution, suspecting that funds stem from a criminal activity, should report their suspicions promptly to the competent authorities. A bank is basically a medium transmitting money in and out. It is required first to identify transactions that are suspicious. Thus, the problem faced by such a financial institution is how to be in compliance with best practice as a reflection of The Forty Recommendations in view of the volume and speed of transactions in current banking systems.

Sophisticated artificial intelligence techniques have been applied to the problem of monitoring fraudulent financial activity. This has been in the belief that such adaptive solutions are the only way to detect the complex and subtle signs that could indicate misbehaviour. Artificial intelligence involves the software in ‘learning’ from its previous analyses to refine its approach. It is not possible for anybody but the most highly trained programmers to tune the procedures once they are set up. Thus, while artificial intelligence itself is adaptive, it does not allow relatively lower level tuning by a user. It is also configured to detect fraud which is not the same as identifying transactions with the potential for financial irregularity for the purposes of compliance.

### SUMMARY OF THE INVENTION

It is an object of the present invention to provide a method of enabling a financial institution to identify transactions that may be suspicious. The present invention provides a new approach to the concept of identifying such transactions by which the financial institution can achieve compliance with prevailing best practice requirements governing financial transaction irregularities.

It is a further object of the invention to provide a system for use by financial institutions that provides a basic framework for providing an alert to potentially suspicious transactions which is user variable according to need and circumstances.

According to one embodiment of the present invention there is provided a method of alerting to the potential for a financial irregularity in a financial transaction. The method is based on a set of rules which assist in providing an alert to the potential for the presence of a financial irregularity in the transaction. Accounts can be monitored to establish a pattern of such transactions. By running the set of rules in respect of a financial transaction in the account, outcomes relative to the established pattern are produced. Such outcomes include any transgressions of the rules indicative of any potential for an irregularity being present. A set of user-established weighting functions can be applied to the outcomes of running the rules, whereby they provide a weighted outcome indicative of the potential for a financial irregularity being present. The weights can be set by the financial institution as user of the method. Similarly, the user can impose thresholds on the degree of transgression of the rules or the cumulative total so that only those rules scoring above a certain threshold level will contribute to an alert of a potentially suspicious transaction. By using a simple set of rules, the user is able to tune the system to specific requirements without recourse to sophisticated programming techniques.

The basis of the invention is the recognition that it is possible to scrutinise in detail a relatively smaller number of transactions that are identified as having a greater potential for being irregular so that a decision can be made on whether to report them to the competent authorities. The invention can operate by assessing what is normal in a set of archived transactions and evaluating each transaction subsequent to the archived set from that datum. In this way the invention is able to identify transactions which could turn out to be worthy of further investigation.

The invention uses the set of individual rules to determine those transactions which are candidates for suspicion. These may be based on the fundamental principles of the value of transaction(s), velocity of the transaction(s) and the volume of transactions effected in the given time.

According to another embodiment of the invention, there is provided a system for identifying a potential for financial irregularity in a financial transaction, comprising: a first database for storing data on at least one selected transaction; a processor loaded with a rules engine, including a set of rules for determining a potential for the presence of financial irregularity in at least one selected transaction, the processor being operable to access the data in the database to run the set of rules in respect of the data and to produce an outcome indicative of the potential for a financial irregularity being present in the transaction.

The invention also extends to a computer-readable medium having computer executable instructions for performing the method of the invention.

### BRIEF DESCRIPTION OF THE DRAWINGS

The present invention can be put into practice in various ways some of which will now be described by way of example with reference to the accompanying drawings in which:

FIG. 1 is a schematic illustration of an overview of the applied system structure for one embodiment of the invention;

FIG. 2 is an illustration of conventional client, account and transaction data;

FIG. 3 is a schematic illustration of the basic sequence according to the embodiment of FIG. 1;

FIG. 4 is a block diagram of a hierarchical structure of a financial institution implementing the invention;

FIG. 5 is a schematic of the rule set architecture;

FIG. 6 is a flow chart for implementing the invention;

FIG. 7 is a flow chart of a first part of the flow chart of FIG. 6;

FIG. 8 is a flow chart of a second part of the flow chart of FIG. 6;

FIG. 9 is a flow chart of a third part of the flow chart of FIG. 6;

FIG. 10 is a flow chart of a fourth part of the flow chart of FIG. 6;

FIG. 11 is a flow chart of a fifth part of the flow chart of FIG. 6;

FIG. 12 is a flow chart of a sixth part of the flow chart of FIG. 6;

FIG. 13 is a flow chart of a seventh part of the flow chart of FIG. 6;

FIG. 14 is an initial screen display;

FIG. 15 is a transaction screen display; and

FIG. 16 is an alert history screen display.

### DETAILED DESCRIPTION OF PREFERRED EMBODIMENTS OF THE INVENTION

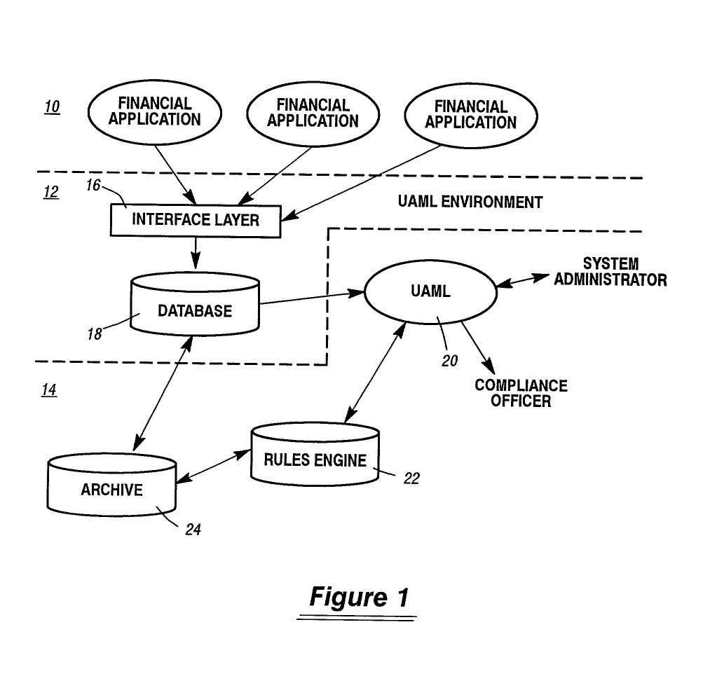

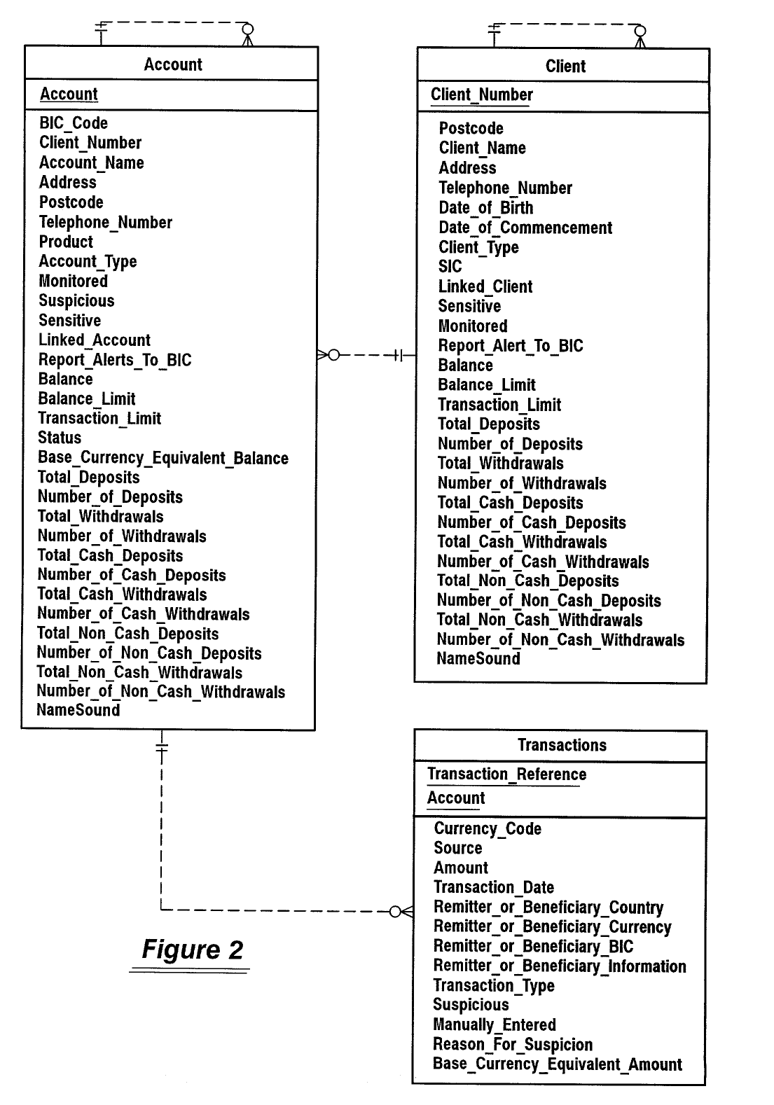

Referring to FIG. 1, a money laundering countermeasures system comprises an application layer 10, a interface layer 12 and an implementation layer 14. Financial applications are typically provided to support bank accounts, such as retail, wholesale, mortgage loan and insurance accounts, held by bank clients. An extract routine 16 at the interface layer 12 is supplied with client, account and financial transaction data from the financial applications at layer 10. These data are stored in a data storage device 18 to form the database that is reviewed at the implementation layer 14 in accordance with the invention. FIG. 2 illustrates the client, account and transaction data that is held in the data storage device 18, as extracted from the financial applications layer 10. The client data forms the basis of the account data. In turn, each transaction associated with an account is based on account data and additional activity data. This is conventional financial data and will not be explained further as it will be well understood by the person of ordinary skill in the art. As illustrated, accounts and clients themselves may be linked or associated for the purposes of transaction analysis.

The implementation layer 14 comprises a money laundering countermeasure processor 20 which accesses the relevant data from the data storage device 18. The accessed data is subjected to a set of fixed (but updatable) rules by a rules engine routine 22 in the processor 20. The outcome of processing the client/account/transaction data according to the rules is a score according to its potential for being a suspicious activity. The data is stored in an archive 24. The outcome of each application of the rules by the rules engine 22 is an output from the processor 20 is a score for the application of each rule relevant to the client/account/transaction data being analysed. These are placed in a compliance monitoring file for review by a compliance officer of the financial institution. The file is reviewed as an output of the system by the compliance officer as containing those analysed transactions having a score based on application of the rules that places them in the category of being worthy of alerting as potentially suspicious events. By imposing a suitable limit on the number of transactions referred to the compliance officer, and by listing the outcomes according to their score in descending order, the number of transactions for human review is kept to a manageable fraction of the total set of transactions analysed in a review period. According to the invention the user is able to prioritise the rules by applying different weighting functions to different rules and according to the circumstances of the financial institution. Thus, the limit on the alerts put before the compliance officer can be set by establishing that the number of alerts that will be shown will be those in a top band of highest scores. Each rule can be effectively disabled by setting the weighting function to zero. The financial institution, as user of the system, can also set thresholds above which a rule is said to be transgressed for the purposes of the transaction analysis. An output for a user is only generated when the threshold is exceeded in the score it achieves as a result of running each rule. Setting the weights, thresholds and limits is an input task carried out by the user's system administrator.

The transactions are downloaded into the database layer 12 and batch processed in a dormant or less busy period of the financial institution's daily or other cycle. For example, the system preferably is a stand-alone arrangement which works on a batch of transactions overnight when the bank is closed for business. Alternatively, the transaction analysis according to the invention can be accomplished at any other convenient frequency and time, such as at weekends. Once the batch of transactions has been processed, those brought to the attention of the compliance officer in the form of an output can be reviewed individually.

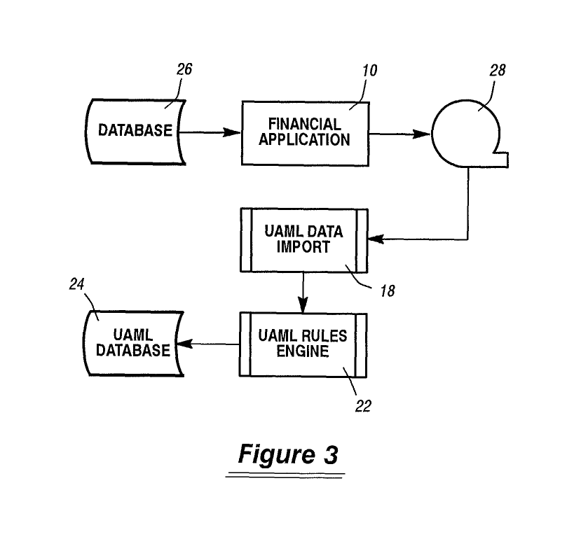

The system of the invention is able to process the transaction data by fetching it using the extract program referred to previously by which it is downloaded to the data storage device 18 which is a sequential file of the data. This is illustrated in FIG. 3. Each financial application 10 has its own database 26 from which the relevant data is extracted by the extract routine 28 to the database 18. The processor 20 reads data from the sequential file 18 and applies the rules engine 22 and commits the transaction to the archive 24. Thus, the system of the invention can process transactions in institutions that use more than one financial application system by extracting the data through the sequential file and normalising it for the purposes of the money laundering countermeasures analysis. Furthermore, by extracting the data from the financial application itself, the money laundering analysis can be conducted without affecting the ability of the financial application to continue processing other transaction data.

The basis to the system of this embodiment of the invention is a rules-based protocol. The rules themselves are explained in more detail below. They are derived from the practical circumstances in which money laundering takes place. As such, their detail is a constantly changing distillation of the mechanisms by which the threat of money laundering can be put into effect. However, while they are loaded in the system, they are each a fixed entity which will lead to a transaction having a score according to the rule applied and its weighting. By simply establishing the rules with separate numerical outcomes the system administrator is able to maintain and tune the system. The rules are based on The Forty Recommendations in the preferred embodiment. However, the detail in the rules is the domain of the skilled person in the particular application and circumstances concerned.

Concerning money laundering countermeasures in a banking institution according to one embodiment of the invention, the rules preferably cover all aspects of the banking business, including retail, personal and corporate transactions, both domestic and international. Because the rules are discrete, the institution itself is able to choose the rules it applies to the various categories of accounts by way of the system administrator. Thus, rules can be tuned to a bank's needs and the profile of the customer base in each category.

The rules in the set are ranked or weighted so that an outcome of an important or significant rule in determining the potential for the presence or absence of money laundering has greater influence on the decision to scrutinise a transaction than a lesser rule. The rankings of all the rules tripped by a transaction will determine the degree of weight allocated to the overall outcome as rules broken in respect of the same transaction/account/client can be grouped in a user output or actually added up to give an overall tally. A transaction that trips a minor group of rules may have a lower accumulated influence than a transaction that might trip only one major rule. The rules are adjustable for sensitivity relative to one another and also overall by the intervention of the system administrator. In the case of relative sensitivity, the rules can be adjusted to suit individual user requirements.

If a transaction scores low in respect of a rule such that it does not appear as a alert strong candidate for further investigation (or does not appear at all if a threshold is used), its risk ranking is simply stored. If a related transaction (i.e. one that belongs to the account or to a linked account or to the client or to a linked client) later trips another rule, the rankings are combined and may cause the account or client common to the combined transactions to be the subject of an alert.

Certain combinations of rules, when broken by the same transaction, can be seen as especially risky. These combinations are termed meta rules. When a meta rule is broken, the transaction takes on the risk ranking of each of the component broken rules, plus an enhanced risk ranking associated with the occurrence of the combination. This serves to promote it in its risk ranking. Central to money laundering countermeasures is the country of source or destination of a transaction. In this embodiment of the invention, an updatable country code list includes every country in the world and weights them according to how concerned the institution should be about receiving finds from or sending funds to each of them. Countries of particular concern are highlighted as ‘hot list countries’. This weighting is derived from guidance issued by such organisations as the OECD and the US Department of the Treasury, Office of Foreign Assets Control (OFAC), and from warnings issued by other governments and regulatory bodies.

In addition, the list of countries indicates whether or not a country is a member of the FATF. This is significant as institutions in FATF member countries are entitled to assume certain standards of conduct about the money laundering countermeasures performed by their peers in other FATF-member countries and regions.

Currencies can be given weightings independently of the jurisdiction involved. Financial transfer mechanisms (such as the system for sending international payment messages operated by the Society for Worldwide Interbank Financial Telecommunication (SWIFT), and automated clearing houses, for example the Clearing House Interbank Payments System (CHIPS) set up by the New York Clearing House for settlement of U.S. international foreign exchange and eurodollar transactions) can be analysed so that weighted rankings can ultimately be given to particular combinations of individual, institution, routing, currency and remitting/receiving jurisdictions. This is a form of meta rule analysis by which certain combinations of rule category violations occurring together represent a transaction with an enhanced likelihood for money laundering potential.

Those wishing to abuse the financial systems to launder money will often seek to escape detection by using several accounts. According to this embodiment of the invention it is possible to combat this by grouping together accounts which are probably linked (for example, several accounts with the same home address or the same customer) and treating their transactions as though they are passing through one account only. This is not an automatic process, but a proactive analytical tool that has to be set up by the system administration staff running the system.

The present invention may also make use of ‘fuzzy matching’ and other analytical tools, such as data mining and generic reporting tools, to allow linking and grouping accounts together. These are well known in themselves to the person of ordinary skill in the art and will not be described in further detail here. Grouped accounts selected by variables can also be re-analysed by one or more rule sets with different sensitivities if required. Thus, the user can look more closely at defined sets of customers using particularly tailored rule set parameters. This can be used to support a particular investigation or in the more general case of undertaking a due diligence exercise, for example during a take-over of one financial institution by another.

When a suspicious transaction becomes an alert by the system according to its score, the compliance officer can choose one of four actions. Firstly, the transaction and/or the account can be archived without action. Secondly, the account can be monitored from the time the alert is made. Thirdly, the account can be referred for a second opinion. Fourthly, the account can be referred direct to the competent authorities policing money laundering in the relevant jurisdiction. Whichever action the compliance officer decides to take, it is preferable that there is a requirement for the compliance officer to enter their reason and that the action taken is password enabled. The alert and the action taken is entered in a log and forms part of a complete ‘audit trail’ of decisions. The log itself is unalterable, although further information can be added to the log at a later date. The system maintains a full history for any account once it is has been marked as suspicious for any reason.

The system is able to generate a number of user-defined management and other reports. For management, the system can report detailed data to be used to control the system, to identify patterns of activity and usage, to develop new business rules and to monitor effectiveness of use. In order to provide evidence of compliance with reporting requirements, the system can produce reports to show, for example, numbers of alerts raised, numbers of alerts as a percentage of transactional volumes and action taken. Generally speaking there are objective and relative sets of rules so that certain types and levels of activity can be caught regardless of the customer type, while others are triggered only in relation to the normal recent activity of that customer or customer type. For example, rules may make reference to a ‘large’ deposit or transfer. ‘Large’ is defined both objectively, as determined by the institution system administrator and according to the usual magnitude of transaction for the type of business, and also relatively, when compared with the usual activity on that account. Further distinctions in the weighting of relative rules are then made according to the transaction type, currency, jurisdiction, and the like.

This embodiment of the invention is particularly suited to the international institution. It can operate across all sectors of a financial group, whatever their location and jurisdiction by extracting data and processing it offline and establishing tuned rule sets for differing local requirements. In such an international institution, it is envisaged that there will be one ‘master’ centre running the system and several ‘junior’ centres, each serving a specific jurisdiction or system environment. The master centre is operably connected with the junior centres to receive data on transactions processed by means of the present invention in order to provide a group overview. As well as allowing different rule sets to be implemented according to jurisdiction or product group, varying reporting filters and thresholds can be imposed locally.

As the present invention has been designed to look for changes in transaction patterns, users of the system are also able to highlight fraudulent transactions as suspicious by means of the same process. A further benefit of this is that the system can be adapted so that the institution can be alerted to those transactions which are intended to defraud the institution itself.

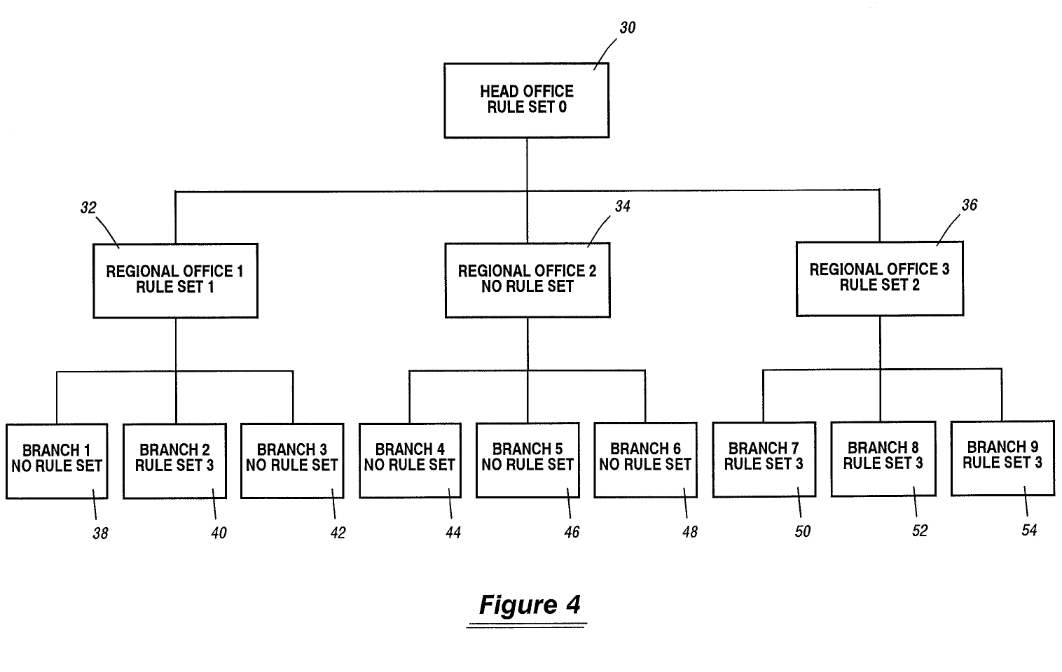

A financial institution having a branch network in which the invention is implemented is shown in FIG. 4. The head office 30 has the dominant Rule Set 0. It has access to the databases of Regional Offices 32, 34 and 36 having either different rule sets or no rule set at all. In the latter case, the money laundering counter measures are conducted in accordance with the invention by the head office 30 using rule set 0. Similarly, branch offices 38 . . . 54 have rule sets overseen by an administrating regional office or have no rule set, passing access to their databases to the superintending regional rule sets or back through to the head office rule set. The institutions can have as many combinations of rule sets as it needs. Different rules and rule weightings can be applied to transactions going through different branches of a bank. This enables local knowledge and concerns to be reflected in which transactions are brought to the attention of the local compliance staff. Rule sets are usually defined to reflect the structure of the organisation so that the rule set which applies to a regional office will also apply to the branches below it in the organisational hierachy, but not necessarily to the head office. Branches may have their own rule sets being applied across transactions, but this functionality enables the organisation to monitor compliance operations at different levels within its organisational structure. It is also possible to arrange for (e.g.) a head office to review the transaction analysis conducted by a branch office by applying its own rule set to the same transactions.

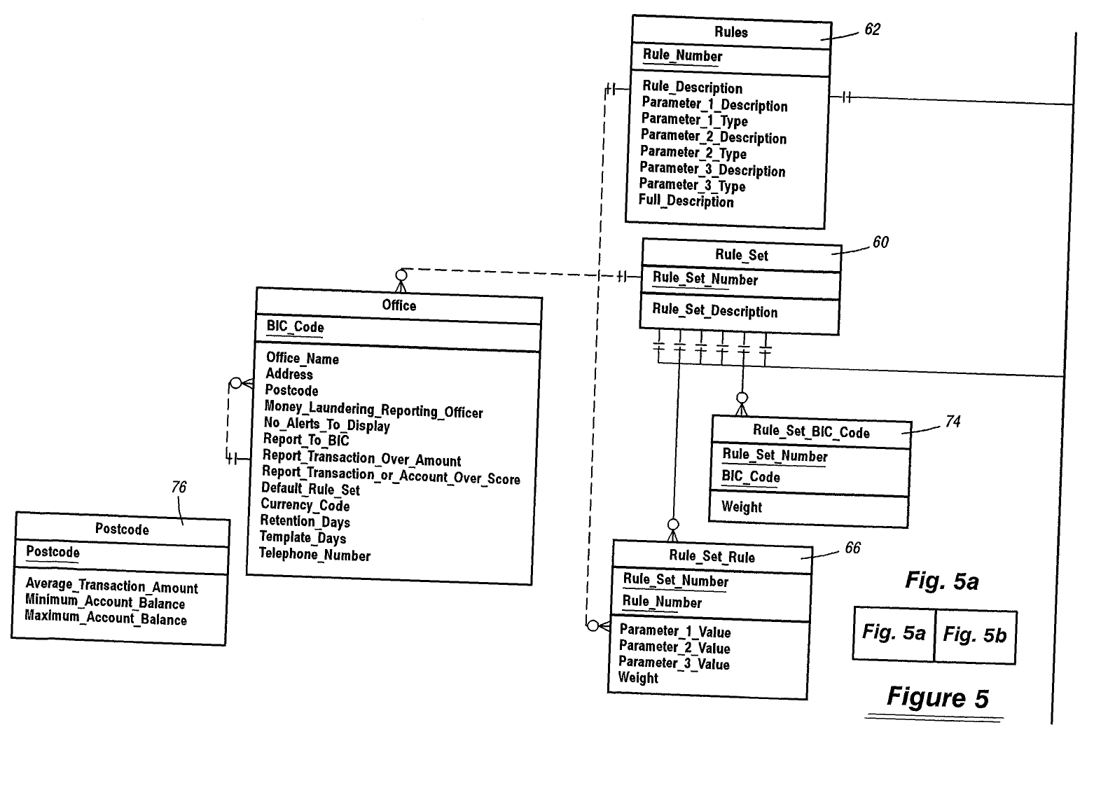

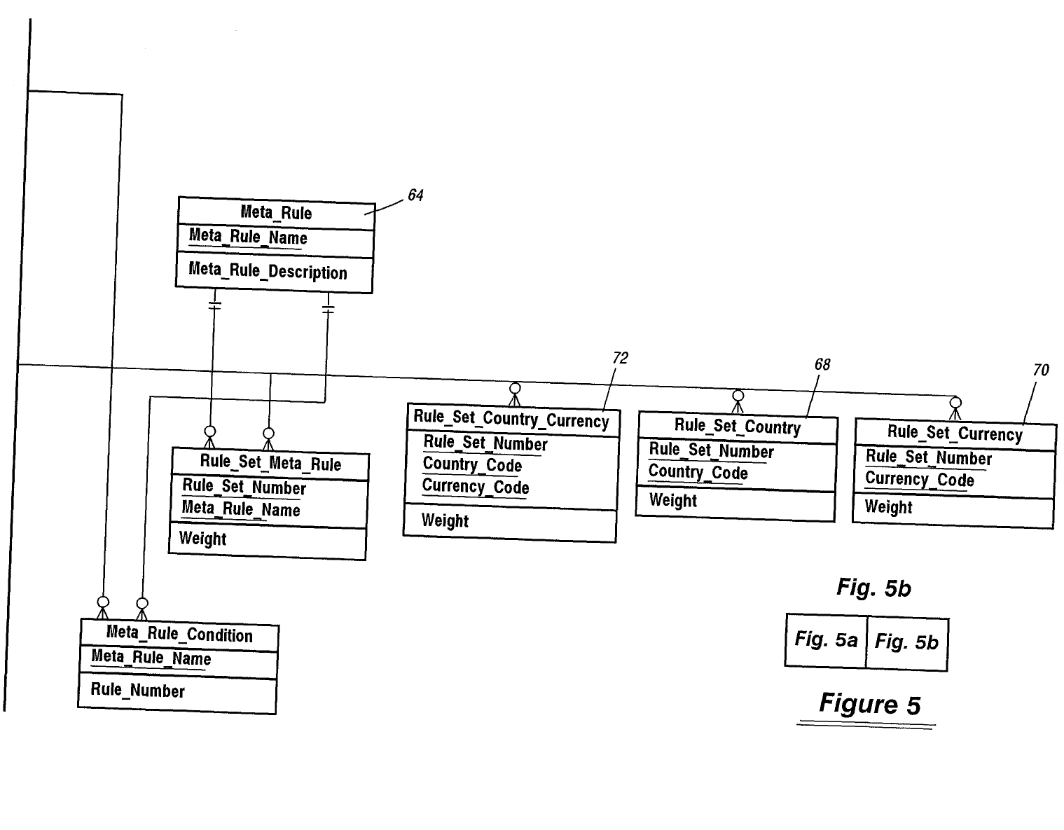

FIG. 5 illustrates the relationship between rule sets and will be used to describe rule sets for transaction and client/account processing according to the invention.

The rule set 60 exists in the rules engine as an owner of a collection of rules. Its only attribute is a description. It has no executables as such. The user of the system according to the invention maintains the Rule Set 60. In FIG. 5 it is marked as the originator of instructions to the various rules under rule set types as described below.

The Rules entity 62 defines the set of rule parameters that can be performed by the system as a whole and from which the Rule Set entity 60 selects the rules for a particular circumstance. The rules themselves will be described in more detail below. The attributes of the Rules entity 62 are a short description (i.e. rule name), a full description (i.e. a descriptor of the rule implemented) and three parameter descriptions. Meta Rules entity 64 is the specified collection of rules which, if broken, will acquire an extra weighting in view of the importance attached to such a combination of broken rules. For example, if the Reggie and Ronnie rules (referred to below) are broken during processing in which deposits are made which are larger than average for a postcode (zipcode) in respect of a balance that is also larger than average for the same postcode, there is heightened cause for suspicion. Both the basic Rules entity 62 and the Meta Rules entity 64 are preferably maintained by the system provider preferably by way of updates at regular intervals to subscribers.

The system user maintains a list in Rule Set Rules entity 66 which can be fine tuned so that the processing conducted by the rules engine specific to the user is relevant to their needs. It is in the Rules Set Rules entity 66 that the user can specify the weightings that will be applied to the rules provided by the system provider.

These are the basic structural components of the system according to the invention. The system is designed such that the user is able to get the benefit of the rules-based processing, but which is fine tuned by the user itself, by adopting those rules relevant to the circumstances, and weighting the rules also according to their importance and relevance to the user situation. The invention also allows the head office to delegate rule fine tuning to branches or regional offices within a group hierachy.

The Rules entity 62 essentially consists of quantitative processes providing outcomes that are positioned on a numerical scale according to the rules adopted and the weightings used when applied to a transaction. In addition, the system of the invention processes transactions according to certain alerting criteria which, if tripped, provide a weighted value according to the presence or absence of that criteria. As with the quantitative rules, these present/absent criteria are weighted to provide a contribution to a total outcome in respect of a transaction. Of course, any one such criterion can exact an ‘alert’ outcome on its own if it is deemed to be a particularly high probability aspect of an irregular transaction.

A Rule Set Country entity 68 allows the user to specify the weights against transactions coming from and destined for specific countries. Countries of high financial standing would normally attract a low weighting value, whereas countries not, for example, subscribing to The Forty Recommendations of FATF (for example) will attract a significantly higher weighting value.

A Rule Set Currency entity 70 allows the user to specify weights against transactions that are in a specific currency. Again, the degree of unreliability of a particular currency will determine the weighting applied to it.

A Rule Set Country Currency entity 72 allows the user to specify weights against transactions in a specific currency coming from or destined for a specific country, i.e. Russian roubles from Austria, to pick an arbitrary example.

A Rule Set BIC (bank identification code) entity 74 allows the user to specify weights against transactions destined for or coming from specific BIC's according to the reliability of the source or destination of the banking transaction being effected.

A Postcode entity 76 allows the user to specify alerting weighting to be assigned to certain postcodes in a jurisdiction. There is no direct relationship between postcode and any of the other rule entities. However, the rules engine will use this to check to see if an account or client has breached transaction limits normally associated with transactions going to or coming from that particular postcode. It is found that postcode analysis in this way is a useful initiator for determining financial irregularities before a pattern specific to a client or account has been built up in the archive 24 of FIG. 1.

Rules engine processing is initiated by the rules engine 22 which is passed either a reference to a client, an account or a transaction and to which the rules set specific to the office of the subscribing financial institution is applied. Analysis has shown that there are two types of rules. Firstly, those that can be applied to transactions. Secondly, those that can be applied to either an account or a client.

A transaction is checked by the rules engine 22 to see the extent to which any of the following rules have been broken, the outcome being in accordance with any thresholds and weightings imposed by the user:

| Rule | Description |
|---|---|
| Cash Placement Objective | Transaction amount exceeds average |
| | transaction amount for the account by a |
| | parameterised limit |
| Cash Placement Relative | Transaction amount exceeds average |
| | transaction amount for the account by a |
| | parameterised percentage |
| Cash Placement Velocity | Number of transactions against the account |
| | has been exceeded by a parameterised |
| | percentage |
| Corruption | Transaction amount exceeds account |
| | transaction limit |
| High Transaction | Transaction amount exceeds parameterised |
| | limit |
| Hot Country | Transaction is destined for or has come from |
| | a hot listed country |
| OFAC | Transaction is destined for or has come from |
| | an OFAC listed country |
| Hot List | I) Transaction is for a hot listed currency |
| | II) Transaction is for a hot listed |
| | country/currency combination |
| | III) Transaction is destined for or has come |
| | from a hot listed BIC |

These are the rules that apply to the transactions data.

Once, all the data for transactions for an account, or linked group of accounts, have been processed, the account data is then passed to the rules engine 22 for processing. Once all the accounts for a client have been processed, the client data will be passed to the rules engine for processing. The following rules are applied against an account or client:

| Rule | Description |
|---|---|
| Bounce | Many small deposits followed by a large withdrawal |
| Dormant | Activity against an account that the user has identified as |
| | being dormant |
| High Balance | Balance exceeds a parameterised limit |
| Mule Smurf | Many deposits over several branches |
| Pooling | Large balance over many accounts or clients |
| Reggie | Deposits larger than average for the postcode |
| Ronnie | Balance larger than average for the postcode |
| Sleeper | Activity against an account or client where there has |
| | been no activity for a parameterised number of days |
| Smurf | Many deposits totalling more than a parameterised limit |
| Suspicious | Activity against an account marked as suspicious already |
| Account | |

The Mule Smurf and Smurf rules may be processed more than once for different types of accounts, such as cash, non-cash and mixed transactions. Linked accounts or clients can be processed together in running these rules.

When processing transaction-related data the interface engine utilises the rules engine to process four categories of data and the associated rules, namely:

Exchange rates

Client-related data

Account-related data

Transaction-related data

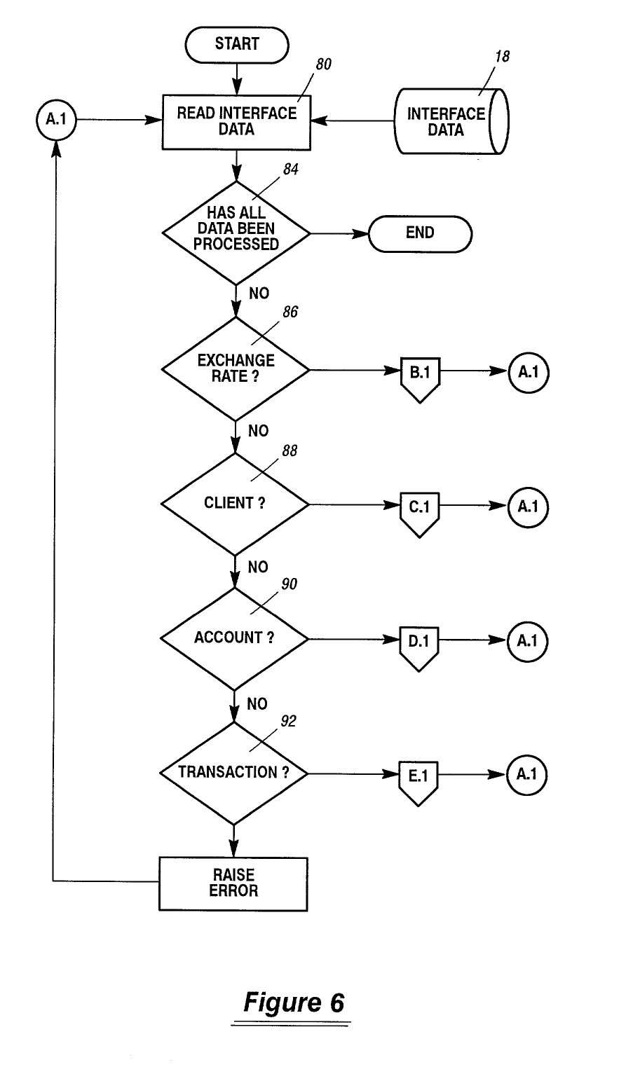

This is illustrated in FIG. 6. The interface data is read at 80 from the interface database 18. If all the data has been processed at step 84, this aspect of the system is complete. If not, the exchange rate, client-related data, account-related data and transaction-related data is updated at steps 86, 90 and 92, respectively.

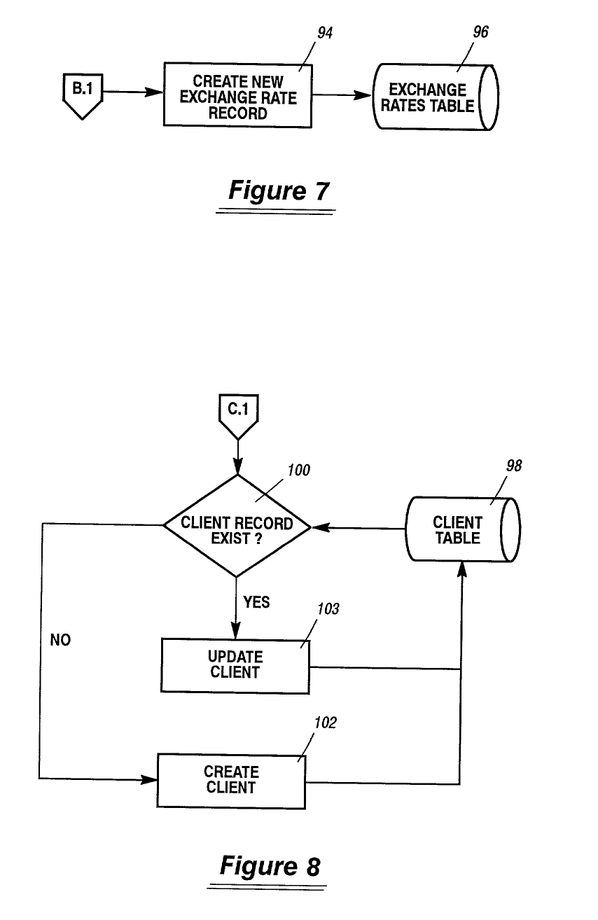

The processes are illustrated in FIGS. 7 to 10. In FIG. 7, at B.1 in FIG. 6 the exchange rate table 96 on which the rules engine is to process transaction-related data is updated by the processor 20 at step 94. These exchange rates are used when converting transaction amounts into base currency. In FIG. 8 at C.1 the processor 20 verifies the existing client data in a client table 98 at step 100 or creates a new client entity in the table at step 102. When a client record exists, it is updated at step 103 and the amended records applied to the client table 98. The option to update is available to pass client data from the financial application running the client to the money laundering countermeasures system. The benefit is that all updates to client and account data (see below) is passed automatically to the countermeasures system.

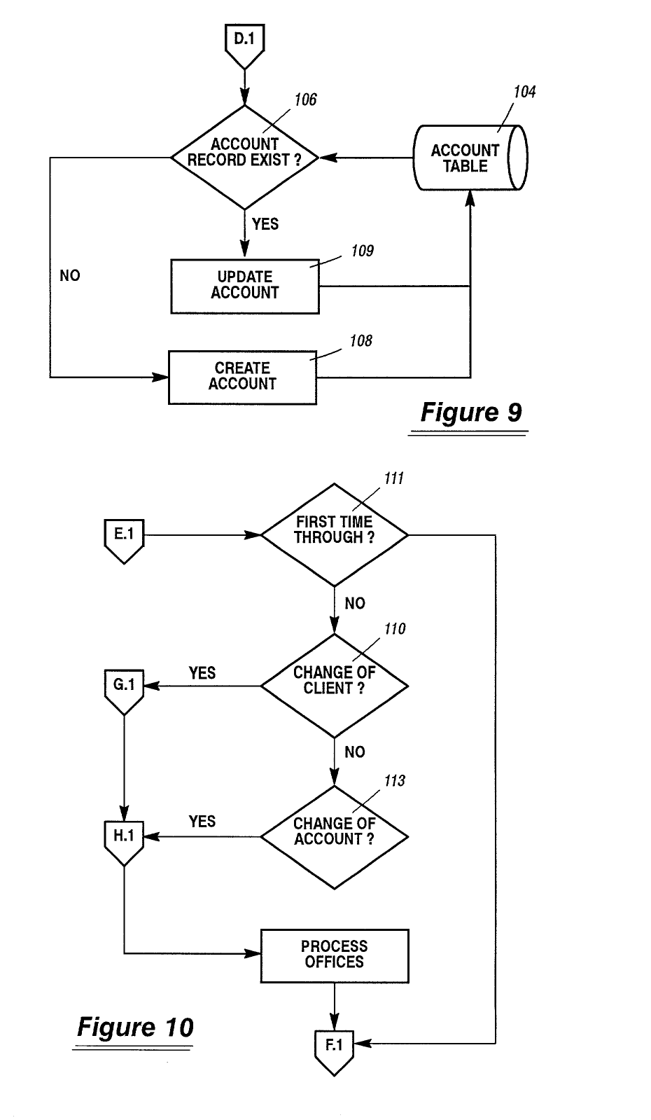

As illustrated in FIG. 9, at D.1 in FIG. 6 the processor 20 loads new accounts and amends existing accounts in an account table 104 with the data passed to it at step 106 or creates an account at step 108 in the account table. When an account record exists, it is updated at step 109 and the amended records applied to the account table 104.

At E.1 in FIG. 6 (shown in FIG. 10) the transaction processing itself is dealt with. Each transaction is treated as a new transaction at E.1. Thus, for each transaction passed to the processor 20, a new transaction entry is created in a transactions table. Before each transaction is loaded, a decision is made as to whether the account or the client has changed, if so the rules set are then applied to a) the account and b) the client. If not the transaction itself can be processed at F.1 described below. Of course, if the transaction in respect of which the client or account is being analysed is the first one, there is no need to run the account/client rules as there will have been no changes. Thus, at step 111 in FIG. 10 this is determined. The account/client rules are bypassed if this is the case and the transaction itself is subjected to its rules at F.1.

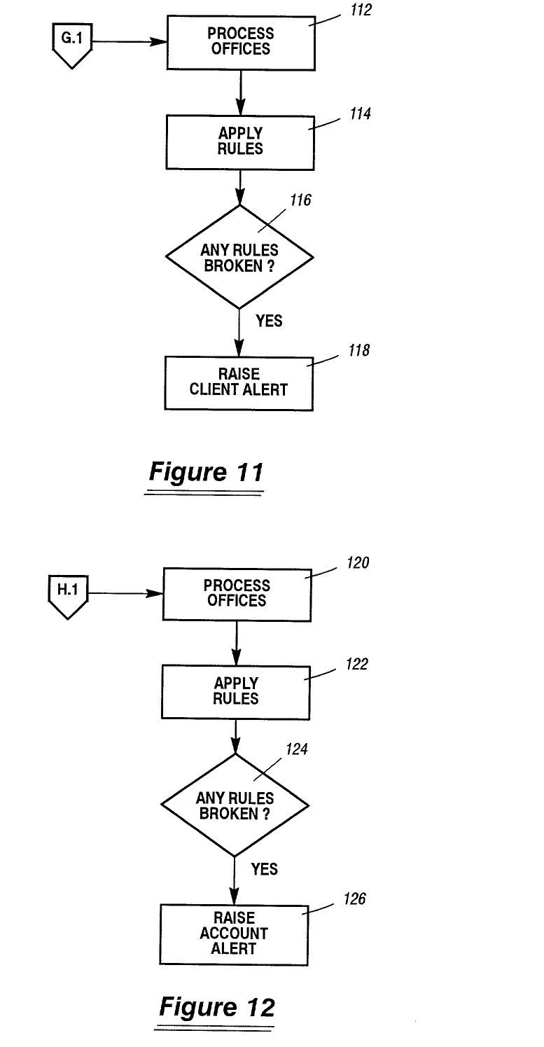

Referring to FIG. 11, if the client is changed at step 110 of FIG. 10 (G.1) the branch or other office of the financial institution having custody of the client is identified at step 112 of FIG. 11. If there has been no change of client, the routine passes to the next stage at step 110. The rule structure making up of the rule set for that branch is fetched such that the rules are applied at step 114. According to the outcome of running the rules a score is produced. This is determined at step 116. According to the score from each of the rules, an alert is sent to the compliance officer (as in FIG. 1) at step 118 if it is sufficiently high relative to the existing alerts to warrant a user output or, alternatively, if it exceeds a threshold imposed on that rule.

In FIG. 12, a similar process is executed in respect of the account rules at H.1 as shown in FIG. 11 for the client rules. The branch or office is identified at step 120, the rules for that branch or office applied at step 122 and a score in respect of breakage of the rules is determined at step 124 as the outcome. The alert is made as an output to the compliance officer at step 126 as necessary. As with clients, at each change of account data at step 113 in FIG. 10, the account based rules are applied against the account. If there are no changes in account data the account rules are not applied.

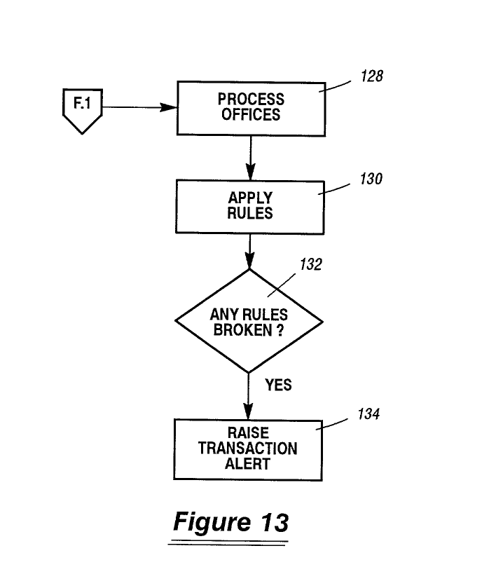

At F.1 in FIG. 6, which is shown in FIG. 13, transaction data is loaded into the database. The rules relevant to the transaction are identified at step 128 for processing the transaction. The rules relevant to transaction data are applied against the transaction at step 130. The determination as to whether any of the applied rules are broken is made at step 132 to give an outcome and an alert issued to the compliance officer at step 134.

The following is a two month transaction history for a fictitious account for an individual.

The following rules have been selected by the financial institution holding the account according to their own selection of rules in the rules engine.

High Transaction—Transaction amount is over a threshold

Cash Placement Velocity—Frequency of cash deposits increases relative to a specified period of account history

Non-cash Bounce—A large non-cash deposit is mirrored by a withdrawal of similar size in a specific time period

Hot Country—The transaction originates from a designated ‘Hot’ country (e.g. Russia)

All the above rules are defined by parameters of amount thresholds and time periods established by the system administrator.

| | Tran | Transaction | Transaction | | Rule |
|---|---|---|---|---|---|
| Date | Ref | Type | Detail | Amount | Broken |
| 25/8 | 12344 | NCASH | Z Ltd | +2105.65 | |
| 1/9 | 12345 | NCASH | Standing order | −34.65 | |
| | | | withdrawal | | |
| 3/9 | 12346 | CASH | Cash | −70.00 | |
| | | | Withdrawal | | |
| 22/9 | 12348 | CASH | Cash | −80.00 | |
| | | | Withdrawal | | |
| 25/9 | 12349 | NCASH | Z Ltd | +2105.65 | |
| 30/9 | 13100 | CASH | Cash | −60.00 | |
| | | | Withdrawal | | |
| 1/10 | 13200 | NCASH | Standing order | −34.65 | |
| | | | withdrawal | | |
| 11/10 | 13566 | CASH | Deposit | +778.50 | |
| 12/10 | 13578 | CASH | Deposit | +540.70 | |
| 12/10 | 13600 | CASH | Deposit | +670.99 | Cash |
| | | | | | Place- |
| | | | | | ment |
| | | | | | Velocity |
| 13/10 | 13642 | CASH | Deposit | +450.34 | Cash |
| | | | | | Place- |
| | | | | | ment |
| | | | | | Velocity |
| 14/10 | 13657 | NCASH | Deposit | +678.56 | Cash |
| | | | | | Place- |
| | | | | | ment |
| | | | | | Velocity |
| 17/10 | 13657 | NCASH | Deposit, | +9800.67 | High |
| | | | Remitter | | Trans- |
| | | | country: | | action |
| | | | Russia | | and Hot |
| | | | | | Country |
| | | | | | (RU) |
| 19/10 | 14567 | NCASH | Withdrawal | −11000.30 | Non- |
| | | | | | Cash |
| | | | | | Bounce |
| | | | | | and High |
| | | | | | Trans- |
| | | | | | action |
| 25/11 | 14589 | Z Ltd | +210565 | | |

Firstly, the Z Ltd deposits are salary and can be discounted as such. From 25/8 through 1/10 there is evidence of what can comfortably be interpreted as ‘normal activity, involving salary deposit and modest withdrawals by cash or standing order. From 10/10 through 19/10 there is evidence of activity that has broken rules because it is within the definition established by the system administrator as being sufficiently suspicious enough to warrant further investigation because it has greater potential for being money laundering.

Transactions 13566, 13578, 13600, 13642, 13657 are deemed as suspicious because none reflects the ‘normal’ activity demonstrated between 25/8 and 1/10 which is stored in the archive. Transaction 13546 is deemed as potentially suspicious because it is the first appearance of a ‘hot’ currency in the account, the fact that it is a hot country in itself and because it breaches the ‘high’ transaction rules. Transaction 14567 is deemed as potentially suspicious because it follows 6 small deposits and is in itself a large withdrawal.

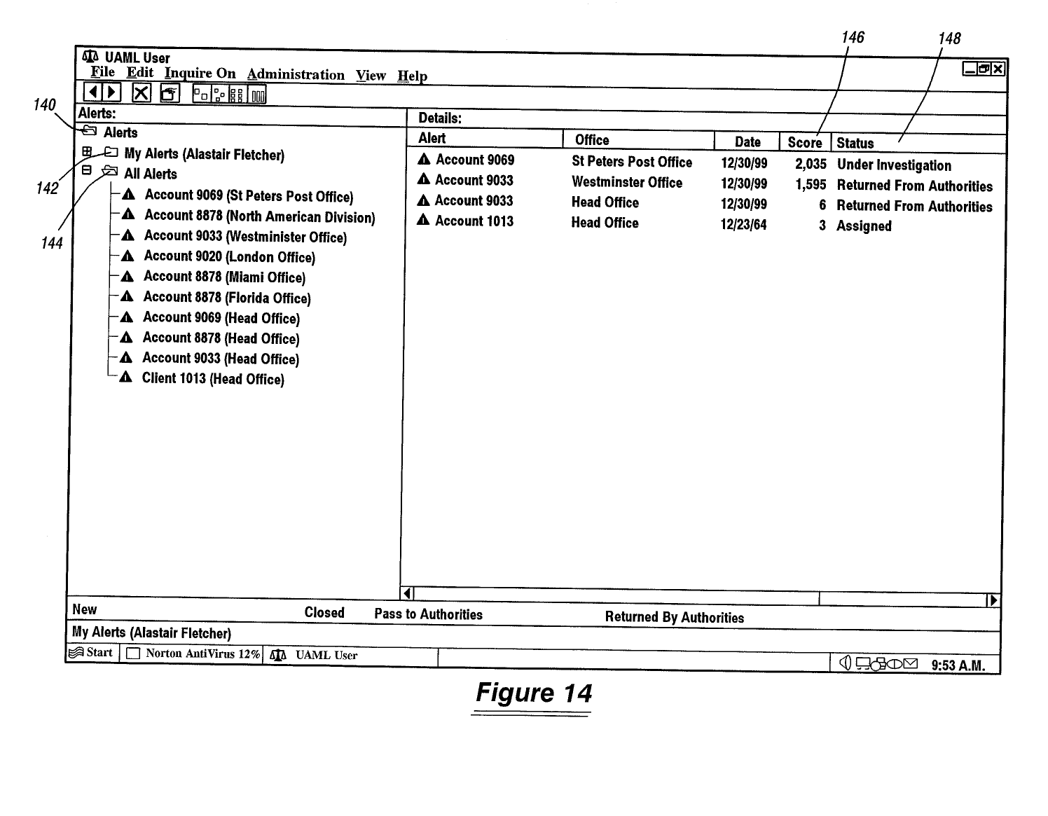

FIG. 14 shows the on-screen display that is available to the head office compliance officer. This is the initial screen showing the Alerts folder 140 and the sub-folders for the compliance officer's alerts 142, and the alerts 144 for the branch offices for the financial institution. The screen shows the Alerts folder 144 is open and the set of three accounts and one client entry that have triggered alerts and their potential for suspicious activity according to the Score column 146. The accounts are listed in order of their accumulated score for the transaction made in respect of it in a review period. The Status column 148 is filled in by the compliance officer according to the action taken.

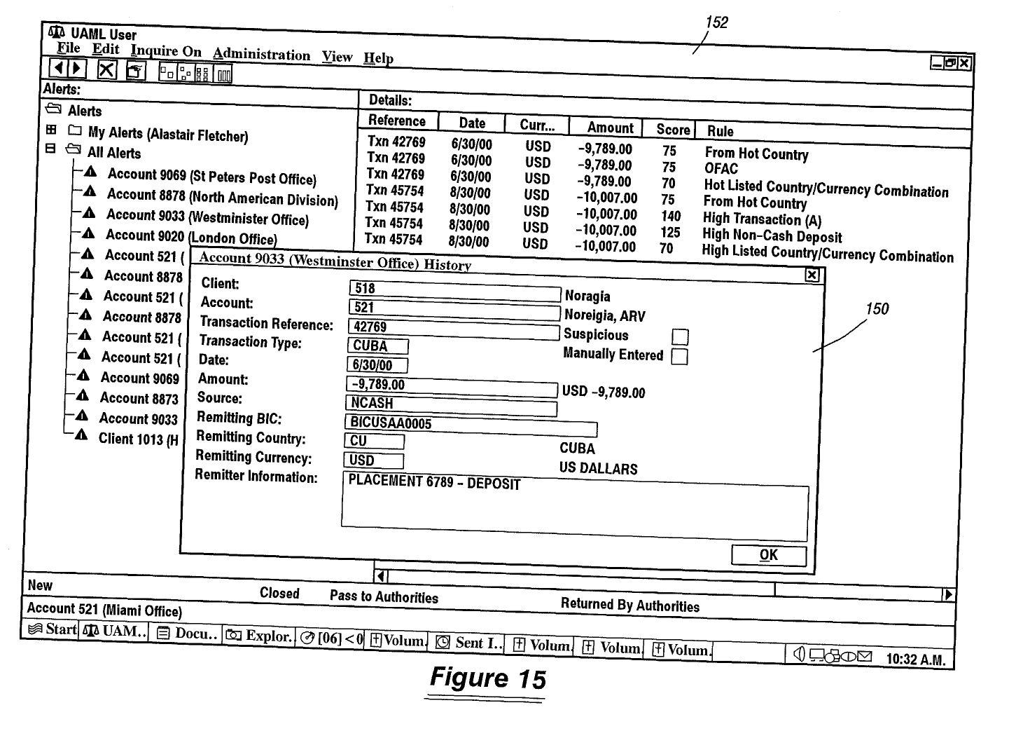

FIG. 15 shows the transaction listing in date order with the Score for each rule broken. Each time a rule is broken it becomes a new entry. A datafile 150 for the alert in respect of transaction Txn42769, for example, is shown at 152. This is accessed by clicking on the transaction entry itself. From the alerts in the background it will be seen that the transaction triggered three rules, namely that it is a transaction from a ‘Hot’ country, an OFAC listed country and constitutes a suspicious country/currency combination. Each entry can be clicked on to access the datafile as part of the archive function. The range of score for each rule can be set by the system administrator. A preferred range is between 0 and 255. The range will determine the level of refinement in the outcomes produced by running each rule. FIG. 15 shows the three triggered rules in respect of transaction 42769 scored 75, 75 and 70, respectively. In FIG. 14 the cumulative total score in respect of each processed account is given, providing an overall impression to the compliance officer of the account from the point of view of the potential for money laundering.

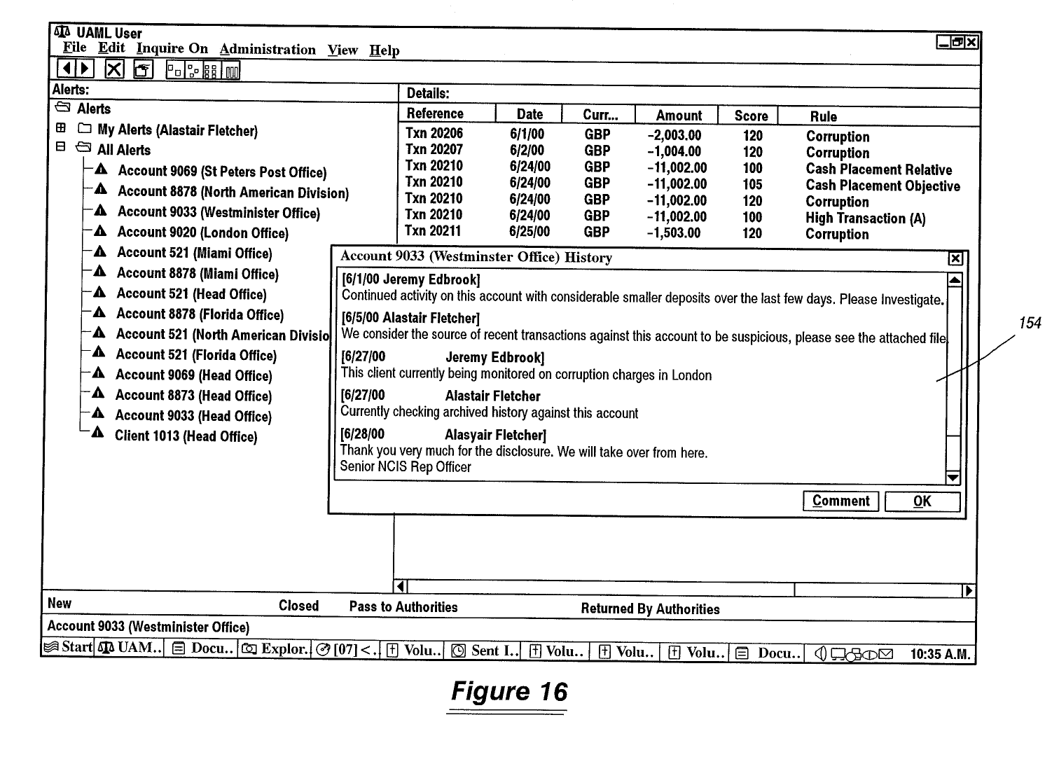

FIG. 16 shows the on-screen display for the account action history 154 associated with account 9033 from the Westminster Office. This is accessed by clicking on the account entry 154.

The platform on which the money laundering countermeasures system of the invention can be run depends on the size of the financial institution using it. The performance of the system will depend upon the capacity and configuration of the technical environment. A small private client institution with, for example, 300 high value clients, with a handful of transactions per day would be able to run the system over a Microsoft™ Access™ database on a laptop. A larger organisation with, for example 300,000 clients processing 100,000 transactions per day may require an enterprise type database, such as Oracle Version 8.0.3 running on a multi-processor facility. A high street bank with millions of accounts and tens of millions of transactions per day would also require an enterprise type database also running on a multi-processor facility. The rules engine itself is arranged to run on Microsoft™ Windows NT™ 4.0 for most applications except the smallest.

The software for the system by which the method of the invention is executed can be stored on any suitable computer readable medium such as floppy disk, computer hard drive, CD-ROM, Flash ROM, non-volatile ROM and RAM. The medium can be magnetically or optically readable. It will be apparent to the person of ordinary skill in the art that variations can be made to the invention. Such variations are intended to be embraced without departing from the spirit and scope of the present invention as defined in the following claims.

1. A system for identifying a potential for financial irregularity in a financial transaction, comprising:
a first database (18) for storing data on at least one selected transaction;
a processor (20) loaded with a rules engine (22), including a predetermined set of rules for determining a potential for the presence of financial irregularity in at least one selected transaction, the processor being operable to access the data in the database to run the predetermined set of rules in respect of the data and to produce an outcome (116, 124, 132) indicative of the potential for a financial irregularity being present in the transaction.

2. The system of claim 1 in which the processor is operable to produce numerical outcome for each rule that is transgressed by the transaction.

3. A system of claim 1 in which the set of rules includes a first group of rules corresponding to client information in the data.

4. The system of claim 1 in which the set of rules includes a second group of rules corresponding to account information in the data.

5. The system of claim 1 in which the set of rules includes a third group of rules corresponding to transaction information in the data.

6. The system of claim 1 in which the processor is operable to combine the outcomes of running at least a selection of the rules in the set to produce an overall outcome indicative of the potential for a financial irregularity.

7. The system of claim 1 in which the processor is further operable to apply a weighting function to the outcome of running each rule according to the importance of the rule to the potential for a financial irregularity being present in the transaction.

8. The system of claim 6 including user input means for varying the weighting function applied to at least one of the rules.

9. The system of claim 1 including user input means for disabling at least one of the rules.

10. The system of claim 2 in which the processor includes a routine for applying a threshold value to each outcome, which routine is arranged to generate an output of transgression of the rule if the threshold is crossed.

11. The system of claim 6 in which the processor includes a routine for applying a threshold value to the overall outcome, which routine is arranged to generate an output indicating the potential for a financial irregularity being present if the threshold is crossed.

12. The system of claim 1 in which at least one of the rules is run in respect of the data to produce the outcome relative to a pattern of activity data corresponding to the rule.

13. The system of claim 12 including an archive for storing the transaction data, the processor means being arranged to access the archive to establish the said pattern based on previous related transactions.

14. The system of claim 1 in which the set of rules includes rules corresponding to client, account and transaction information, the set of rules being selected from the group comprising:
a) transaction amount exceeds average transaction amount for the account by a parameterised limit;
b) transaction amount exceeds average transaction amount for the account by a parameterised percentage;
c) number of transactions against the account has been exceeded by a parameterised percentage;
d) transaction amount exceeds account transaction limit;
e) transaction amount exceeds parameterised limit;
f) transaction is destined for or has come from a listed country;
g) transaction is destined for or has come from an OFAC listed country;
h) i) transaction is for a listed currency;
ii) transaction is for a listed country/currency combination;
iii) transaction is destined for or has come from a listed financial institution;
i) many small deposits followed by a large withdrawal;
j) activity against an account that the user has identified as being dormant;
k) balance exceeds a parameterised limit;
l) many deposits over several branches of the user;
m) large balance over many accounts or clients;
n) deposits larger than average for the postcode;
o) balance larger than average for the postcode;
p) activity against an account or client where there has been no activity for a parameterised period; and
q) activity against an account marked as suspicious already.

15. The system of claim 7 in which a further weighting function is applied to a predefined collection of rules which are transgressed in respect of the same or related transactions.

16. The system of claim 1 in which the financial transaction is a bank transaction.

17. The system of claim 1 in which the financial irregularity is money laundering.

18. The system of claim 1 in which the processor includes an extract routine for accessing transaction data from a second database and for transferring the said data to the said first database.

19. The system of claim 1 in which the outcome is translated into a user alert indicative of the potential for the presence of a financial irregularity in the transaction.

20. The system of claim 10 in which the said output is a user-readable alert.

21. The system of claim 11 in which the said output is a user-readable alert.

22. A method of identifying a potential for financial irregularity in a financial transaction, comprising:
storing data (18) on at least one selected transaction;
running the at least one selected transaction through a predetermined set of rules (22) for detecting a potential for the presence of financial irregularity therein to produce an outcome (116, 124, 132) indicative of the potential for a financial irregularity being present in the transaction.

23. A method of claim 22 in which a numerical outcome is produced for each rule that is transgressed by the transaction.

24. The method of claim 22 in which the set of rules includes a first group of rules corresponding to client information in the data.

25. The method of claim 22 in which the set of rules includes a second group of rules corresponding to account information in the data.

26. The method of claim 22 in which the set of rules includes a third group of rules corresponding to transaction information in the data.

27. The method of claim 22 in which the outcomes of running at least a selection of the rules in the set is combined to produce an overall outcome indicative of the potential for a financial irregularity.

28. The method of claim 22 in which a weighting function is applied to the outcome of running each rule according to the importance of the rule to the potential for a financial irregularity being present in the transaction.

29. The method of claim 28 including varying the weighting function applied to at least one of the rules by user input.

30. The method of claim 27 including disabling at least one of the rules by user input.

31. The method of claim 22 including applying a threshold value to each outcome and generating an output for transgression of the rule if the threshold is crossed.

32. The method of claim 27 including applying a threshold value to the overall outcome and generating an output indicating the potential for a financial irregularity being present if the threshold is crossed.

33. The method of claim 22 including running at least one of the rules in respect of the transaction data to produce the outcome relative to a pattern of activity data corresponding to the rule.

34. The method of claim 33 including storing the data in an archive and accessing the archive to establish the said pattern based on previous related transactions.

35. The method of claim 22 in which the set of rules include rules corresponding to client, account and transaction information, the set of rules being selected from the group comprising:
a) transaction amount exceeds average transaction amount for the account by a parameterised limit;
b) transaction amount exceeds average transaction amount for the account by a parameterised percentage;
c) number of transactions against the account has been exceeded by a parameterised percentage;
d) transaction amount exceeds account transaction limit;
e) transaction amount exceeds parameterised limit;
f) transaction is destined for or has come from a listed country;
g) transaction is destined for or has come from an OFAC listed country;
h) i) transaction is for a listed currency;
ii) transaction is for a listed country/currency combination;
iii) transaction is destined for or has come from a listed financial institution;
i) many small deposits followed by a large withdrawal;
j) activity against an account that the user has identified as being dormant;
k) balance exceeds a parameterised limit;
l) many deposits over several branches of the user;
m) large balance over many accounts or clients;
n) deposits larger than average for the postcode;
o) balance larger than average for the postcode;
p) activity against an account or client where there has been no activity for a parameterised period; and
q) activity against an account marked as suspicious already

36. The method of claim 27 including applying a further weighting function to a predefined collection of rules which are transgressed in respect of the same or related transactions.

37. The method of claim 22 in which the financial transaction is a bank transaction.

38. The method of claim 22 in which the financial irregularity is money laundering.

39. The method of claim 22 including extracting transaction data from a second database associated with a financial application and transferring the said data to the first database.

40. The method of claim 22 in which the outcome is translated into a user alert indicative of the potential for the presence of a financial irregularity in the transaction data.

41. The method of claim 31 including generating the said output as a user-readable alert.

42. The method of claim 32 including generating the said output as a user-readable alert.

43. A method of identifying a potential for money laundering in a financial transaction associated with a financial institution, comprising:
extracting data on the transaction from a financial transaction account database and storing the transaction data in a second database;
running the financial transaction through a set of rules for detecting a potential for the presence of a financial irregularity therein by transgression of one or more of the rules and to produce an outcome indicative of the potential for a financial irregularity being present in the transaction;
weighting the outcome of running the financial transaction through the set of rules;
producing a user-readable output of the rules if any transgression exceeds a predetermined threshold;
providing a user operable input device by which to set the weights against each rule; and
providing a user operable input device by which to set the threshold in respect of the set of rules.

44. A computer-readable medium having computer-executable instructions for performing a method comprising:
storing data (18) on at least one selected transaction;
running the at least one selected transaction through a predetermined set of rules (22) for detecting a potential for the presence of financial irregularity therein to produce an outcome (116, 124, 132) indicative of the potential for a financial irregularity being present in the transaction.

45. The computer readable medium of claim 44 performing the method in which a numerical outcome is produced for each rule that is transgressed by the transaction.

46. The computer readable medium of claim 44 performing the method in which the set of rules includes a first group of rules corresponding to client information in the data.

47. The computer readable medium of claim 44 performing the method in which the set of rules includes a second group of rules corresponding to account information in the data.

48. The computer readable medium of claim 44 performing the method in which the set of rules includes a third group of rules corresponding to transaction information in the data.

49. The computer readable medium of claim 44 performing the method in which the outcomes of running at least a selection of the rules in the set is combined to produce an overall outcome indicative of the potential for a financial irregularity.

50. The computer readable medium of claim 44 performing the method in which a weighting function is applied to the outcome of running each rule according to the importance of the rule to the potential for a financial irregularity being present in the transaction.

51. The computer readable medium of claim 50 performing the method including varying the weighting function applied to at least one of the rules by user input.

52. The computer readable medium of claim 44 performing the method including disabling at least one of the rules by user input.

53. The computer readable medium of claim 44 performing the method including applying a threshold value to each outcome and generating an output for transgression of the rule if the threshold is crossed.

54. The computer readable medium of claim 49 performing the method including applying a threshold value to the overall outcome and generating an output indicating the potential for a financial irregularity being present if the threshold is crossed.

55. The computer readable medium of claim 44 performing the method including running at least one of the rules in respect of the transaction data to produce the outcome relative to a pattern of activity data corresponding to the rule.

56. The computer readable medium of claim 55 performing the method including storing the data in an archive and accessing the archive to establish the said pattern based on previous related transactions.

57. The computer readable medium of claim 44 performing the method in which the set of rules include rules corresponding to client, account and transaction information, the set of rules being selected from the group comprising:
a) transaction amount exceeds average transaction amount for the account by a parameterised limit;
b) transaction amount exceeds average transaction amount for the account by a parameterised percentage;
c) number of transactions against the account has been exceeded by a parameterised percentage;
d) transaction amount exceeds account transaction limit;
e) transaction amount exceeds parameterised limit;
f) transaction is destined for or has come from a listed country;
g) transaction is destined for or has come from an OFAC listed country;
h) i) transaction is for a listed currency;
ii) transaction is for a listed country/currency combination;
iii) transaction is destined for or has come from a listed financial institution;
i) many small deposits followed by a large withdrawal;
j) activity against an account that the user has identified as being dormant;
k) balance exceeds a parameterised limit;
l) many deposits over several branches of the user;
m) large balance over many accounts or clients;
n) deposits larger than average for the postcode;
o) balance larger than average for the postcode;
p) activity against an account or client where there has been no activity for a parameterised period; and
q) activity against an account marked as suspicious already

58. The computer readable medium of claim 49 performing the method including applying a further weighting function to a predefined collection of rules which are transgressed in respect of the same or related transactions.

59. The computer readable medium of claim 44 performing the method in which the financial transaction is a bank transaction.

60. The computer readable medium of claim 44 performing the method in which the financial irregularity is money laundering.

61. The computer readable medium of claim 44 performing the method including extracting transaction data from a second database associated with a financial application and transferring the said data to the first database.

62. The computer readable medium of claim 44 performing the method in which the outcome is translated into a user alert indicative of the potential for the presence of a financial irregularity in the transaction data.

63. The computer readable medium of claim 53 performing the method including generating the said output as a user-readable alert.

64. The computer readable medium of claim 54 performing the method including generating the said output as a user-readable.

65. A computer-readable medium having computer-executable instructions for performing a method comprising:
extracting data on the transaction from a financial transaction account database and storing the transaction data in a second database;
running the financial transaction through a set of rules for detecting a potential for the presence of a financial irregularity therein by transgression of one or more of the rules and to produce an outcome indicative of the potential for a financial irregularity being present in the transaction;
weighting the outcome of running the financial transaction through the set of rules;
producing a user-readable output of the rules if any transgression exceeds a predetermined threshold;
providing a user operable input device by which to set the weights against each rule; and
providing a user operable input device by which to set the threshold in respect of the set of rules.
